(19) United States
(12) Patent Application Publication
(10) Pub. No.: US 2005/0203947 A1
(43) Pub. Date: Sep. 15, 2005

(54) Imposing and recovering correlithm objects

(75) Inventors: Douglas J. Matzke, Plano, TX (US); P. Nick Lawrence, Dallas, TX (US)

Correspondence Address: BAKER BOTTS L.L.P., 2001 ROSS AVENUE, SUITE 600, DALLAS, TX, 75201-2980, US

(73) Assignee: Lawrence Technologies,LLC

(21) Appl. No.: 10/796,946

(22) Filed: Mar. 10, 2004

(51) Int. Cl. G06F 15/18; G06F 7/00; G06F 17/00; A63F 3/00

(52) U.S. Cl. 707/103 R; 706/26; 706/16

(57) ABSTRACT

Manipulating correlithm objects includes establishing correlithm objects of an N-dimensional space, where a correlithm object is a point of the space. The correlithm objects are imposed on the space to yield a combined point. An imposed correlithm object is compared to the combined point. The imposed correlithm object is recovered in accordance with the comparison.

### GOVERNMENT FUNDING

The U.S. Government may have certain rights in this invention as provided for by the terms of SBIR contract No. F30602-03-C-0051 awarded by the United States Air Force.

### TECHNICAL FIELD OF THE INVENTION

This invention relates generally to the field of correlithm objects and more specifically to imposing and recovering correlithm objects.

### BACKGROUND OF THE INVENTION

Tokens may be used to provide interaction for agents in a shared resource such as a shared state space or medium. Concurrent tokens may be used to provide simultaneous interaction. Known techniques typically utilize precisely orthogonal tokens that are independent of each other when summed together according to vector math principles. The use of precisely orthogonal tokens, however, is not efficient in certain situations. It is generally desirable to use efficient techniques in certain situations.

### SUMMARY OF THE INVENTION

In accordance with the present invention, disadvantages and problems associated with previous techniques for representing concurrent tokens in a shared resource may be reduced or eliminated.

According to one embodiment of the present invention, manipulating correlithm objects includes establishing correlithm objects of an N-dimensional space, where a correlithm object is a point of the space. The correlithm objects are imposed on the space to yield a combined point. An imposed reference correlithm object is compared to the combined point. The imposed correlithm object is recovered in accordance with the comparison.

Certain embodiments of the invention may provide one or more technical advantages. A technical advantage of one embodiment may be that correlithm objects may be used to generate nearly orthogonal overlap codes. Typically, for a given N-dimensional space, a larger number of nearly orthogonal overlap codes than precisely orthogonal codes can be generated.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a diagram illustrating example random correlithm objects that may be used to form nearly orthogonal vectors;

FIG. 2 is a block diagram illustrating one embodiment of a system for generating correlithm object tokens;

FIG. 3 is a block diagram illustrating one embodiment of a system for imposing and recovering correlithm objects used as correlithm object tokens; and

FIG. 4 is a flowchart illustrating one embodiment of a method for imposing and recovering correlithm objects that may be used with the system of FIG. 3.

### DETAILED DESCRIPTION OF THE DRAWINGS

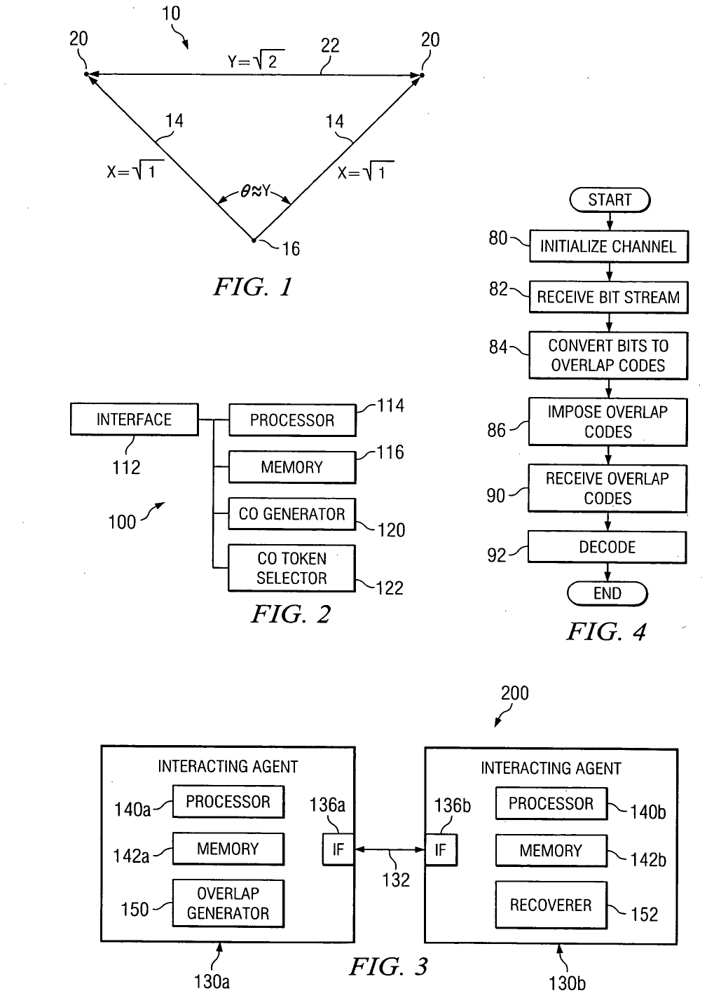

Embodiments of the present invention and its advantages are best understood by referring to FIGS. 1 through 4 of the drawings, like numerals being used for like and corresponding parts of the various drawings.

FIG. 1 is a diagram 10 illustrating example randomly generated correlithm objects that may be used to form nearly orthogonal vectors. A correlithm object may be used, for example, to represent states of an agent such as a process in memory or a device. According to one embodiment, two or more correlithm objects may be imposed on and recovered from the same correlithm object space representing a shared resource such as a shared medium. Accordingly, multiple agents may exist in the same space. According to one embodiment, correlithm objects may be randomly generated to yield tokens that may be used as concurrent overlap codes. Randomly generating correlithm objects produces nearly orthogonal overlap codes, in contrast to the precisely orthogonal codes traditionally used in other techniques. A larger number of nearly orthogonal codes may be more readily generated than traditional precisely orthogonal codes.

In general, a correlithm object comprises a point of a correlithm object space. A correlithm object may be used as a representation of a token or a code. According to one embodiment, a correlithm object may represent a point of a generalized M-dimensional sub-space S of a particular N-space, where 0≦M≦N. A generalized sub-space comprises a sub-space for which the participation of each dimension from the N-space has been defined, where participation describes the degree to which a dimension is contained within the sub-space. A dimension may be completely contained within a sub-space, fractionally contained within the sub-space, or completely outside of the sub-space. Other embodiments of correlithm object may be used without departing from the scope of this disclosure.

A correlithm object may have any suitable number of entries. For example, a correlithm object may include at least twenty, such as thirty, one hundred, one thousand, or ten thousand entries, for example, between one hundred and one thousand entries. An entry may include real numbers, complex numbers, or other suitable values. According to one embodiment, an entry may represent any suitable number of bits of significance, where each bit of significance is represented within one or more-numbers such as binary, real, or complex numbers. In this document, the term “each” refers to each of at least a subset of the identified items.

A random correlithm object comprises a random point of a correlithm object space. Any suitable distribution of correlithm objects may be used. According to one embodiment, uniformly distributed random correlithm objects may be used. As the number of dimensions of space S increases, randomly selected correlithm objects exhibit standard metrics. A standard metric refers to a standardized distance metric such as a standard distance, a standard radius, a standard corner-corner distance, a standard corner-point distance, or other suitable standardized distance metric.

Standard Distance and Standard Radius

According to the illustrated embodiment, random points 20 represent randomly selected correlithm objects with N dimensions or cells. Vectors 14 originate at a center point 16, and each vector 14 is directed at a random point 20. Center point 16 may represent the average of many correlithm objects, and is typically the midpoint of the correlithm object space, the correlithm object distribution, or both. According to one embodiment, each vector 14 may represent a state of an agent such as a process or device.

“Standard distance” refers to the distance between random points 20, and “standard radius” refers to the distance between center point 16 and a random point 20. Random points 20 tend to lie at an approximately standard distance from one another, and the distance between a random point 20 and center point 16 approaches an approximately standard radius. The standard radius is typically shorter than the standard distance by approximately \sqrt{½}. For example, the standard radius for a unit cube with a standard distance of \sqrt{N/6} is approximately \sqrt{n/12}. This standard radius is statistical, and has a constant standard deviation of approximately \sqrt{1/60} for large N.

According to the illustrated embodiment, random points 20 lie at a normalized standard radius X=\sqrt{1} of approximately unit length from center point 16 and at a normalized standard distance Y=\sqrt{2} from each other.

Standard Metrics for a Bounded Space

“Standard corner-corner distance” refers to the distance between any two randomly chosen corners of a bounded space. For example, the corners of a unit N-cube typically have coordinates values that are binary values (0 or 1). The standard corner-corner distance may be calculated as the Cartesian distance, which is equivalent to the square root of the Hamming distance, yielding approximately \sqrt{N/2}. The standard corner-corner distance is statistical and has a constant standard deviation of approximately \sqrt{½}³≈30.3535 for large N.

“Standard corner-point distance” refers to the standard distance between a randomly chosen corner and a random point 20 inside of a bounded space. For example, the standard corner-point distance for a unit N-cube is approximately the value of \sqrt{N/3}, which is approximately twice the standard radius between center point 16 of the unit N-cube and a random corner of approximately

$$\sqrt{\frac{N}{12}} .$$

The standard corner-point distance may be generalized for any space, and may be slightly different depending on the distribution of random points 20 within the space compared to the size of the bounding space. The standard corner-point distance is statistical and has a constant standard deviation that is independent of N.

Nearly Orthogonal Vectors

Vector 14 originates from center point 16 and is directed to a random point 20, where angle θ is the angle between vectors 14. The inner product of vectors 14 is approximately zero, that is, vectors 14 are nearly orthogonal according to the Pythagorean Theorem. According to one embodiment, vectors 14 may be nearly orthogonal, that is, have approximately unit lengths and be nearly orthogonal. Precisely orthogonal vectors have a separation of exactly 90°, that is, the inner product of the vectors is substantially equal to zero. Nearly orthogonal vectors may have a statistical variation of the separation 90°±v, where typically the statistical variation v<5°, but can be as much as v<15°.

The number of dimensions of random points 20 may be used to control the standard deviation of angle θ. For example, random points 20 with one hundred entries may have a standard deviation of approximately four degrees, random points 20 with one thousand entries may have a standard deviation of approximately one degree, and random points 20 with three thousand entries may have a standard deviation of less than one degree. Accordingly, vectors 14 may become naturally more orthogonal as the number of dimensions increases. The number of dimensions may be, for example, greater than 100 dimensions.

Random points 20 formed into vectors 14 may themselves be considered to be nearly orthogonal. If the space is symmetric around zero, then center point 16 is located at zero. Under these conditions, the representation for random point 20 is identical to the representation for vector 14, which may facilitate the dual manner of computing for points or vectors without any translation. The expected values for the standard angle and inner product metric are independent of N, but statistical, and the normalized standard deviation is dependent on 1/N, resulting in more closely orthogonal points 20 for larger N.

Normalization with Standard Radius

Normalization yields nearly orthonormal random points 16. The standard metrics are intrinsic for correlithm object distributions, so any suitable standard metric may be used for normalization. For example, the standard radius may be used to normalize the metrics. Normalized metrics are not dependent on N and approximate the square root of a small integer value. For a unit cube, the normalized value for the standard radius is approximately 1, for the expected value of the standard distance is approximately \sqrt{2}, for the standard corner-point distance is approximately \sqrt{4}, and for the standard corner-corner distance is approximately \sqrt{6}. The normalized values may be generalized for any bounded space, and the standard distance remains at approximately \sqrt{2} due to the Pythagorean Theorem.

Normalized standard deviations have the form \sqrt{x/N}, where x is some small constant value. For example, for a unit cube, the normalized deviation of standard distance is \sqrt{7/10N}. Therefore, as N increases the normalized standard deviations shrinks to 0.

Recoverable Correlithm Objects

Random points 20 representing correlithm objects may be imposed on and recovered from the same space S. “Imposing” points on a space may refer to expressing the points as a combined point in the space, and “recovering” points from the space may refer to retrieving the individual points from the combined point. For example, a space may include a number K of correlithm objects represented by points p₁, . . . , pᵢ, . . . , p_{K}, where K>1. Points pᵢ may be imposed on space S to yield a single point P of space S. Points pᵢ may be imposed according to any suitable technique. For example, points pᵢ may be imposed by performing an imposing operation such as summation on a dimension-by-dimension basis, which is equivalent to vector addition. An imposed point pᵢ may be recovered by comparing point P to the point pᵢ using any suitable technique. For example, an imposed point pᵢ may be recovered by performing a recovery operation on imposed point pᵢ and combined point p, such as calculating a metric such as a Cartesian distance or an inner product.

Imposed points pᵢ share a certain amount of available discrimination D of space S used to recover the points, where D may be measured in bits. According to one embodiment, available discrimination D in an N-dimensional space is approximately N/σ bits, where σ is approximately \sqrt{7/120}, the standard deviation of the expected distance between two points pᵢ of an N-dimensional unit cube. If K points pᵢ are imposed on space S, then an available discrimination for a point comprising D/K bits of information may be available to discriminate each of the imposed points pᵢ. Typically, in physical implementations of imposed and recovered points pᵢ, there may be a noise floor. If D/K is greater than the noise floor, then each of the imposed points pᵢ may be individually recovered. The points pᵢ may still be recoverable to a decreasing degree as D/K equals or drops below the noise floor. If two points pᵢ have no dimensions in common, then they may be completely recoverable. If two points pᵢ have at least one dimension in common, then the points pᵢ may not be completely recoverable at D/K bits.

The recoverability of correlithm objects may allow for the useful representation of states by correlithm objects. According to one embodiment, a correlithm object may represent a state of a state space for an agent, where an agent may comprise, for example, a process in memory or a physical device. One or more agents may each have one or more unique correlithm objects that represent states for the agent, and the correlithm objects may constitute a private state machine space for the agent. The spaces may be disjoint or overlapping. Two or more agents may execute concurrently within the same space if random correlithm object tokens are globally unique for each state machine space.

According to one embodiment, the recoverability of correlithm objects may provide for correlithm object (CO) tokens, which may be used as overlap codes. As discussed above, randomly generated correlithm objects are nearly orthogonal, in particular as the number of dimensions N increases. For example, the number of dimensions may be relatively large such as greater than 1000. Accordingly, randomly generated correlithm objects may be used as nearly orthogonal tokens. As N increases, the tokens naturally become more orthogonal, thus more closely approximating the characteristics of precisely orthogonal tokens. The less orthogonal the tokens, the more inter-symbol interference occurs between simultaneous agents during the concurrent use of a shared resource.

Correlithm objects may provide for a greatly increased number of available tokens. For an N-dimensional space, only N precisely orthogonal tokens exist. Random correlithm objects, however, may be readily generated to produce nearly orthogonal tokens. Techniques may be implemented to select random correlithm objects that produce nearly orthogonal tokens with a narrower standard deviation of inner angle. For example, tokens may be pre-screened using, for example, N-M-J codes. As another example, unacceptable tokens may be filtered to discard poor candidates to yield a narrowed distribution set, which may produce improved orthogonality.

Modifications, additions, or omissions may be made to the example without departing from the scope of the invention. For example, the distances illustrated in FIG. 1 have been normalized using the standard radius X. Different distances may be obtained using other normalizing factors. As another example, vectors 14 may have angles θ other than 90°.

FIG. 2 is a block diagram illustrating one embodiment of a system 100 for generating correlithm object (CO) tokens. According to the illustrated embodiment, system 100 includes an interface 112, one or more processors 114, a memory 116, a CO generator 120, and a CO token selector 122 coupled as shown. System 100, however, may include any general purpose or custom modules suitable for generating appropriate distributions of correlithm object tokens.

“Interface” refers to any suitable structure of a device operable to receive input for the device, send output from the device, or both, and may comprise one or more ports. “Processor” refers to any suitable device operable to function according to instructions. Processor 114 may comprise, for example, a personal computer, work station, network computer, wireless telephone, personal digital assistant, one or more microprocessors, other suitable processing device, or any combination of the preceding. “Memory” refers to any structure operable to store data. Memory 116 may comprise Random Access Memory (RAM), Read Only Memory (ROM), a magnetic drive, a disk drive, a Compact Disk (CD) Drive, a Digital Video Disk (DVD) drive, removable media storage, any other suitable data storage device, or a combination of the preceding.

CO generator 120 randomly generates correlithm objects that may be used as CO tokens. CO generator 120 may utilize any suitable random number generator that uses any suitable random number generation process, such as a cyclic redundancy process, other process, or any combination of the preceding. According to one embodiment, a correlithm object token may comprise a correlithm object that has D bits represented by N cells. For unit cube, the number of bits-per-dimension may be approximately four bits per dimension such as 4.14 bits per dimension or typically less depending on the resolution per dimension. Each cell value may comprise a randomly selected value, for example, a binary value, a complex number, or a real number of the appropriate resolution. The cell values may have specific ranges and distributions. For example, the cell values may be symmetric around, for example, zero. A distribution is invariant under scaling and translation, so different distribution spaces may be statistically equivalent, which may facilitate implementation of encoding and recovery.

CO generator 120 may generate simulated random correlithm objects by randomly assigning values such as real or complex numbers to simulated entities. As an example, if complex numbers are expressed in rectangular form with variables a and b, values may be randomly selected for a and b. As another example, if complex numbers are expressed in phasor form with magnitude r and phase angle α, magnitude r may be set equal to a constant such as one and values between 0 and 2π may be randomly selected for phase angle α. As yet another example, if complex numbers are expressed in phasor form, values between zero and one inclusive may be randomly selected for magnitude r and values between 0 and 2π may be randomly selected for phase angle α. The values may be randomly assigned according to any suitable random process. A random process may comprise, for example, a cyclic redundancy algorithm, which may sometimes include a power of two limitation used by PN generators, other suitable physical random process, or any combination of the preceding.

CO generator 120 may generate CO tokens by generating a complement of a token, where the inner product of a token and its compliment token is −1. For every random token, there is a unique complement token that may be used as a token, which may double the number of available tokens. The token and its complement token have a normalized distance that is twice the normalized standard radius for the tokens, and the normalized standard distance is only the square root of two between random tokens. The use of the complement token may provide for a larger discriminating distance, which may improve the recovery rate of concurrent correlithm objects, and may also reduce the number of unique symbols that inject inter-symbol noise.

Complementary CO tokens may be generated in any suitable manner. In symmetric spaces with distributions around the point [0, 0, . . . , 0], the complement of a token may be computed by multiplying the token times −1. In asymmetric spaces, the complement of a token may be computed by first translating the space by subtracting the midpoint of the distribution, which is typically the midpoint of the space, from the token to yield a first intermediate term. Then, the intermediate term may be multiplied by −1 to yield a second intermediate term. Finally, the midpoint may be added to the second intermediate term to yield the complement in the original space before translation. This process may be used for any suitable dimensional value including binary, real, or complex valued points.

CO token selector 120 operates to increase the orthogonality of the tokens. Increasing orthogonality reduces inter-symbol interference, which may improve recovery. According to one embodiment, tokens may be found to be unacceptable according to a threshold based on a feature of a specific set of tokens such as unfiltered tokens or previously accepted tokens. As an example, tokens may be filtered in accordance with the distribution of standard distances of unfiltered tokens. A minimum distance threshold may be selected to narrow the standard deviation of the distribution of standard distances of unfiltered tokens. As an example, the standard deviation may be narrowed to approximately 50% to 75% of unfiltered tokens. Selecting a higher minimum distance threshold more than 85% of the standard distance may improve orthogonality, but may also decrease the number of acceptable tokens found using random processes.

The modules of system 100 may be integrated or separated according to particular needs. For example, the functions of the modules of system 100 may be provided using a single computer system, for example, a single personal computer. Any of the modules of system 100 may be coupled to another module using one or more networks, a global computer network such as the Internet, or any other appropriate wireline, wireless, or other links.

Modifications, additions, or omissions may be made to system 100 without departing from the scope of the invention. Moreover, the operations of system 100 may be performed by more, fewer, or other modules. For example, the operations of CO generator 120 and CO token selector 122 may be performed by one module, or the operations of CO token selector 122 may be performed by more than one module. Additionally, functions may be performed using any suitable logic comprising software, hardware, other logic, naturally occurring phenomena that models the behavior, or any suitable combination of the preceding. Additionally, correlithm object tokens may be prepared ahead of time and stored for later use, or they may be generated and then immediately used.

FIG. 3 is a block diagram illustrating one embodiment of a system 200 for imposing and recovering correlithm objects used as CO tokens. According to the illustrated embodiment, system 200 includes interacting agents 130 coupled by one or more shared resources such as a memory system or electromagnetic or equivalent channels 132 as shown. A source agent 130a imposes a correlithm object by superimposing information into a shared medium using a CO token as an overlap code. Detector agent 130b recovers the correlithm object using a matching CO token as a matching detector code. System 200 may impose and recover correlithm objects to impose CO tokens in a shared resource in order to compute, communicate, store, or any other combination of the preceding. As an example, source agent 130a may communicate information across a distance to detector agent 130b. As another example, source agent 130a may store information for a duration for later retrieval by detector agent 130b.

An interacting agent 130 may comprise any agent operable to interact locally or remotely with another agent, for example, a computer, a personal digital assistant, a cellular telephone, a mobile handset, a satellite, a process, a base station, or other agent. According to the illustrated embodiment, interacting agents 130 each include an interface (IF) 136, one or more processors 140, and a memory 142. Interacting agents 130 may, however, include more, fewer, or other hardware, software, or other structure for computation, communication, storage, or any combination of the preceding. Although this example system 200 includes agents 130, system 200 may instead include any other agent operable to impose a correlithm object or any other agent operable to recover a correlithm object.

Source agent 130a includes an overlap generator 150. Overlap generator 150 operates to impose a correlithm object by representing information using a CO token as an overlap code. Detector agent 130b includes a code recoverer 152. Recoverer 152 operates to recover a correlithm object by detecting information using a matching CO token as a detector code.

According to one embodiment, vectors may be used to represent tokens. For example, p random vectors Xᵢ of length N, i=1, . . . , p may represent a set of p tokens x, and q random vectors Yⱼ of length N, j=1, . . . , q may represent a set of q tokens y. Concurrent tokens x and y may be imposed by summing their corresponding Xᵢ and Yⱼ vectors to yield a combined state Z with elements Z[k]=(Xᵢ[k]+Yⱼ[k]), for k=1, . . . , N. To recover token x, the Cartesian distance (or inner product) of Z with each of the Xᵢ may be computed. The recovered token x is ith vector that has the smallest distance metric (or largest inner product) A similar procedure may be used to recover token y.

According to one embodiment, the length of an overlap code may be less than or equal to the dimensional length. If less than, a binary mask may be used. The mask may be integrated into a recovery token table or stored separately to allow the same codes to be shared by source agent 130a.

A token assignee that is assigned a token may comprise a logical channel 132 or a number of simultaneous users. A user may refer to a user account for an interaction service or to interacting agent 130 itself. A user may be identified by a user identifier comprising, for example, a logical name, other suitable identifier, or any combination of the preceding. As discussed above, CO tokens may be readily generated to yield a relatively large number of available overlap codes. Accordingly, more token assignees may be assigned tokens, more tokens may be assigned to a token assignee, or a combination of both.

According to the embodiment, users may be dynamically assigned a certain number of tokens based on the transfer rate desired. For example, if there are fewer users of the shared resource, a user may have more tokens, but if there are more users of the shared resource, a user may use fewer tokens. According to one embodiment, a user may increase its number of tokens using one or more sub-entities, each with their own tokens. Each sub-entity may utilize the amount of available discrimination of the shared space. According to one embodiment, each user may act as multiple agents by pre-combining the tokens of the sub-entities to utilize the amount of available discrimination. A sub-entity may be created by adding an agent in the hardware of source agent 130a.

Techniques may be used to coordinate control over the sub-entities. For example, specific token sets may be defined to coordinate control. As another example, the sub-entities may share a set of tokens with other sub-entities instead of having unique tokens. A sub-entity generally may use a token only if it is not being used by another sub-entity.

According to one embodiment, interacting agents 130 may agree upon a randomly generated set of tokens unknown by other such agents. Accordingly, other interacting agents may be restricted from interpreting the information shared between such agents 130. According to one embodiment, the tokens may be periodically randomly generated during the computation, communication, storage, or any combination of the preceding. Multiple sets of pre-established tokens may be generated prior to initialization, and interacting agents 130 may agree upon a set or sequence of tokens during initialization.

Alterations or permutations such as modifications, additions, or omissions may be made to system 200 without departing from the scope of the invention. System 200 may have more, fewer, or other modules. Moreover, the operations of system 100 may be performed by more, fewer, or other modules. For example, the operations of overlap generator 150 may be performed by more than one module. Additionally, operations of system 200 may be performed using any suitable logic comprising software, hardware, other logic, or any suitable combination of the preceding.

FIG. 4 is a flowchart illustrating one embodiment of a method for imposing and recovering correlithm objects that may be used with system 200 of FIG. 3. According to the embodiment, overlap generator 50 of source agent 130a may convert bits into overlap codes. Recovery agent 52 of detector agent 130b decodes the overlap codes using matching codes.

The method begins at step 80, where channel 132 between interacting agents 130 is initialized. During initialization, codes of one or more tokens may be shared between interacting agents 130. Bits are received at overlap generator 150 of source agent 30a at step 82. Overlap generator 150 converts the bits to overlap codes at step 84. The overlap codes are imposed into a shared resource at step 86. According to one embodiment, the results from some or all of the source agents 130a may be summed explicitly or naturally by the shared resource to produce overall equivalent values in the space. A normalization process may be explicitly or automatically performed on the sum, but normalization may not be required due to scaling invariance.

The combined overlap codes are received by recovery agent 52 of detector agent 130b at step 90. The overlap codes are detected at step 92. According to one embodiment, metrics such as the Cartesian distance, the inner product, other suitable operation, or any combination of the preceding may be computed for each of the detector codes. Time delayed sliding windows of these operations may also be performed. After decoding the overlap codes, the method terminates.

Alterations or permutations such as modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that correlithm objects may be used to generate nearly orthogonal overlap codes. Typically, larger numbers of nearly orthogonal overlap codes can be generated than precisely orthogonal codes.

Although an embodiment of the invention and its advantages are described in detail, a person skilled in the art could make various alterations, additions, and omissions without departing from the spirit and scope of the present invention as defined by the appended claims.

1. A method for manipulating a plurality of correlithm objects, comprising:
establishing a plurality of correlithm objects of a space, the space comprising an N-dimensional space, a correlithm object comprising a point of the space;
imposing the plurality correlithm objects on the space to yield a combined point;
comparing an imposed correlithm object to the combined point; and
recovering the imposed correlithm object in accordance with the comparison.

2. The method of claim 1, further comprising randomly generating the plurality of correlithm objects.

3. The method of claim 1, wherein imposing the plurality correlithm objects on the space to yield the combined point further comprises performing an imposing operation on the plurality of correlithm objects.

4. The method of claim 1, wherein comparing the imposed correlithm object to the combined point further comprises performing a recovery operation on the imposed correlithm object and the combined point.

5. The method of claim 1, further comprising:
establishing one or more agents, each agent associated with a state space; and
assigning one or more of the plurality of correlithm objects to each agent, the one or more correlithm objects representing a state of the agent to which the one or more correlithm objects are assigned.

6. The method of claim 1, wherein the plurality of correlithm objects are nearly orthogonal.

7. The method of claim 1, further comprising utilizing a correlithm object of the plurality of correlithm objects as a correlithm object token.

8. The method of claim 1, wherein imposing the plurality correlithm objects on the space to yield the combined point further comprises performing computation using the plurality of correlithm objects.

9. The method of claim 1, wherein imposing the plurality correlithm objects on the space to yield the combined point further comprises storing the plurality of correlithm objects.

10. The method of claim 1, wherein imposing the plurality correlithm objects on the space to yield the combined point further comprises communicating the plurality of correlithm objects.

11. A system for manipulating a plurality of correlithm objects, comprising:
an overlap generator operable to:
establish a plurality of correlithm objects of a space, the space comprising an N-dimensional space, a correlithm object comprising a point of the space; and
impose the plurality correlithm objects on the space to yield a combined point; and
a recoverer coupled to the overlap generator and operable to:
compare an imposed correlithm object to the combined point; and
recover the imposed correlithm object in accordance with the comparison.

12. The system of claim 11, further comprising a processor coupled to the overlap generator and operable to randomly generate the plurality of correlithm objects.

13. The system of claim 11, the overlap generator and operable to impose the plurality correlithm objects on the space to yield the combined point by performing an imposing operation on the plurality of correlithm objects.

14. The system of claim 11, the recoverer operable to compare the imposed correlithm object to the combined point by performing a recovery operation on the imposed correlithm object and the combined point.

15. The system of claim 11, further comprising a processor coupled to the overlap generator and operable to:
establish one or more agents, each agent associated with a state space; and
assign one or more of the plurality of correlithm objects to each agent, the one or more correlithm objects representing a state of the agent to which the one or more correlithm objects are assigned.

16. The system of claim 11, wherein the plurality of correlithm objects are nearly orthogonal.

17. The system of claim 11, further comprising a processor coupled to the overlap generator and operable to utilize a correlithm object of the plurality of correlithm objects as a correlithm object token.

18. The system of claim 11, the overlap generator and operable to impose the plurality correlithm objects on the space to yield the combined point by performing computation using the plurality of correlithm objects.

19. The system of claim 11, the overlap generator and operable to impose the plurality correlithm objects on the space to yield the combined point by storing the plurality of correlithm objects.

20. The system of claim 11, the overlap generator and operable to impose the plurality correlithm objects on the space to yield the combined point by communicating the plurality of correlithm objects.

21. Logic for manipulating a plurality of correlithm objects, the logic embodied in a medium and operable to:
establish a plurality of correlithm objects of a space, the space comprising an N-dimensional space, a correlithm object comprising a point of the space;
impose the plurality correlithm objects on the space to yield a combined point;
compare an imposed correlithm object to the combined point; and
recover the imposed correlithm object in accordance with the comparison.

22. The logic of claim 21, further operable to randomly generate the plurality of correlithm objects.

23. The logic of claim 21, operable to impose the plurality correlithm objects on the space to yield the combined point by performing an imposing operation on the plurality of correlithm objects.

24. The logic of claim 21, operable to compare the imposed correlithm object to the combined point by performing a recovery operation on the imposed correlithm object and the combined point.

25. The logic of claim 21, further operable to:
establish one or more agents, each agent associated with a state space; and
assign one or more of the plurality of correlithm objects to each agent, the one or more correlithm objects representing a state of the agent to which the one or more correlithm objects are assigned.

26. The logic of claim 21, wherein the plurality of correlithm objects are nearly orthogonal.

27. The logic of claim 21, further operable to utilize a correlithm object of the plurality of correlithm objects as a correlithm object token.

28. The logic of claim 21, operable to impose the plurality correlithm objects on the space to yield the combined point by performing computation using the plurality of correlithm objects.

29. The logic of claim 21, operable to impose the plurality correlithm objects on the space to yield the combined point by storing the plurality of correlithm objects.

30. The logic of claim 21, operable to impose the plurality correlithm objects on the space to yield the combined point by communicating the plurality of correlithm objects.

31. A system for manipulating a plurality of correlithm objects, comprising:
means for establishing a plurality of correlithm objects of a space, the space comprising an N-dimensional space, a correlithm object comprising a point of the space;
means for imposing the plurality correlithm objects on the space to yield a combined point;
means for comparing an imposed correlithm object to the combined point; and
means for recovering the imposed correlithm object in accordance with the comparison.

32. A method for manipulating a plurality of correlithm objects, comprising:
establishing a plurality of correlithm objects of a space, the space comprising an N-dimensional space, a correlithm object comprising a point of the space, the plurality of correlithm objects being randomly generated, the plurality of correlithm objects being nearly orthogonal, a correlithm object of the plurality of correlithm objects being utilized as a correlithm object token;
imposing the plurality correlithm objects on the space to yield a combined point by performing an imposing operation on the plurality of correlithm objects, the plurality correlithm objects imposed to perform at least one of: performing computation using the plurality of correlithm objects, communicating the plurality of correlithm objects, and storing the plurality of correlithm objects;
comparing an imposed correlithm object to the combined point by performing a recovery operation on the imposed correlithm object and the combined point;
recovering the imposed correlithm object in accordance with the comparison;
establishing one or more agents, each agent associated with a state space; and
assigning one or more of the plurality of correlithm objects to each agent, the one or more correlithm objects representing a state of the agent to which the one or more correlithm objects are assigned.

33. A method for generating tokens, comprising:
randomly generating a plurality of correlithm objects of a space, the space comprising an N-dimensional space, a correlithm object comprising a point of the space; and
selecting one or more of the plurality of correlithm objects as one or more correlithm object tokens, the one or more correlithm object tokens being nearly orthogonal.

34. The method of claim 33, wherein randomly generating the plurality of correlithm objects of the space further comprises generating a random correlithm object by randomly selecting one or more values for one or more entries of the random correlithm object.

35. The method of claim 33, further comprising:
selecting a correlithm object of the plurality of correlithm objects;
generating a token complement of the selected correlithm object; and
using the token complement as a correlithm object token.

36. The method of claim 33, wherein selecting the one or more of the plurality of correlithm objects as the one or more correlithm object tokens further comprises:
establishing a distance threshold associated with a standard metric of the plurality of correlithm objects; and
selecting the one or more correlithm objects that satisfy the distance threshold as the one or more correlithm object tokens.

37. A system for generating tokens, comprising:
a memory operable to store information; and
a processor coupled to the memory and operable to:
randomly generate a plurality of correlithm objects of a space, the space comprising an N-dimensional space, a correlithm object comprising a point of the space; and
select one or more of the plurality of correlithm objects as one or more correlithm object tokens, the one or more correlithm object tokens being nearly orthogonal.

38. The system of claim 37, the processor operable to randomly generate the plurality of correlithm objects of the space by generating a random correlithm object by randomly selecting one or more values for one or more entries of the random correlithm object.

39. The system of claim 37, the processor further operable to:
select a correlithm object of the plurality of correlithm objects;
generate a token complement of the selected correlithm object; and
use the token complement as a correlithm object token.

40. The system of claim 37, the processor further operable to select the one or more of the plurality of correlithm objects as the one or more correlithm object tokens by:
establishing a distance threshold associated with a standard metric of the plurality of correlithm objects; and
selecting the one or more correlithm objects that satisfy the distance threshold as the one or more correlithm object tokens.

41. Logic for generating tokens, the logic embodied in a medium and operable to:
randomly generate a plurality of correlithm objects of a space, the space comprising an N-dimensional space, a correlithm object comprising a point of the space; and
select one or more of the plurality of correlithm objects as one or more correlithm object tokens, the one or more correlithm object tokens being nearly orthogonal.

42. The logic of claim 41, operable to randomly generate the plurality of correlithm objects of the space by generating a random correlithm object by randomly selecting one or more values for one or more entries of the random correlithm object.

43. The logic of claim 41, further operable to:
select a correlithm object of the plurality of correlithm objects;
generate a token complement of the selected correlithm object; and
use the token complement as a correlithm object token.

44. The logic of claim 41, operable to select the one or more of the plurality of correlithm objects as the one or more correlithm object tokens by:
establishing a distance threshold associated with a standard metric of the plurality of correlithm objects; and
selecting the one or more correlithm objects that satisfy the distance threshold as the one or more correlithm object tokens.

45. A system for generating tokens, comprising:
means for randomly generating a plurality of correlithm objects of a space, the space comprising an N-dimensional space, a correlithm object comprising a point of the space; and
means for selecting one or more of the plurality of correlithm objects as one or more correlithm object tokens, the one or more correlithm object tokens being nearly orthogonal.

46. A method for generating tokens, comprising:
randomly generating a plurality of correlithm objects of a space, the space comprising an N-dimensional space, a correlithm object comprising a point of the space, the plurality of correlithm objects generated by randomly selecting one or more values for one or more entries of the random correlithm object;
selecting one or more of the plurality of correlithm objects as one or more correlithm object tokens, the one or more correlithm object tokens being nearly orthogonal, the one or more of the plurality of correlithm objects selected by:
establishing a distance threshold associated with a standard metric of the plurality of correlithm objects; and
selecting the one or more correlithm objects that satisfy the distance threshold as the one or more correlithm object tokens;
selecting a correlithm object of the plurality of correlithm objects;
generating a token complement of the selected correlithm object; and
using the token complement as a correlithm object token.
